(19) United States
(12) Patent Application Publication
(10) Pub. No.: US 2025/0215975 A1
(43) Pub. Date: Jul. 3, 2025

(54) SEAL COMPRISING A SUCCESSION OF ZONES WITH AND WITHOUT ANTI-FRICTION COATINGS

(71) Applicant: SAFRAN NACELLES, GONFREVILLE-L'ORCHER (FR)

(72) Inventors: Jean-Phillippe JORET, MOISSY-CRAMAYEL (FR); Charles-Antoine LAMPAERT, MOISSY-CRAMAYEL (FR); Philippe AVENEL, MOISSY-CRAMAYEL (FR); Manuel RODRIGUEZ ARENAS, MOISSY-CRAMAYEL (FR)

(73) Assignee: SAFRAN NACELLES, GONFREVILLE-L'ORCHER (FR)

(21) Appl. No.: 18/847,976

(22) PCT Filed: Mar. 8, 2023
(86) PCT No.: PCT/FR2023/050315

§ 371 Date: Sep. 17, 2024

(30) Foreign Application Priority Data
Mar. 17, 2022 (FR) 2202340

(51) Int. Cl. F16J 15/02; B64D 45/00

(52) U.S. Cl. CPC F16J 15/027; B64D 45/00; B64D 2045/009

(57) ABSTRACT

A seal is configured to be arranged between a first element and a second element of a propulsion assembly. The seal includes a longitudinal sector designed to be in contact with the second element, wherein the longitudinal sector is formed of an elastic leak-tight material and includes a first zone having an anti-friction coating, a second zone having a leak-tight coating, and a third zone having an anti-friction coating. The first, second and third zones arranged side by side and extend longitudinally from a first end to a second end of the longitudinal sector.

### TECHNICAL FIELD

The present invention relates to a seal for a propulsion unit, and more particularly to a fire-proof and fluid-tight seal for a propulsion unit.

For example, the propulsion unit may be an assembly of the turbojet engine and nacelle type for the propulsion of aircraft.

In general, the invention applies to any field requiring the set-up of a fluid-tight seal, the seal could be substantially set in motion.

### PRIOR ART

In the field of nacelles for aircraft turbojet engines, various compartments are positioned proximate one another, some could contain flammable liquids, and others could be exposed to a fire or sparks, in any case should the liquid pass from one compartment to another.

For example, FIG. 1 shows a schematic section of a nacelle 1 of a turbojet engine.

The nacelle comprises a thrust reverser 3 placed downstream, as well as an engine 5 positioned at the centre of the nacelle on its longitudinal axis 7.

Access to the engine 5 is performed through a first compartment 9, so-called engine compartment. In particular, access to said first compartment 9 is performed through the opening of a movable cowl 11.

The nacelle also comprises a second compartment 13 juxtaposed with the first compartment 9 and comprising a piece of equipment for servo-controlling the thrust reverser 3.

The first compartment 9 comprises hoses comprising flammable fluids. Upon an incident such as a pipe burst, the fluids are released into the first compartment 9 and might ignite. Moreover, the first compartment 9 and the equipment inside the first compartment 9 is designed to withstand in the event of fire, the first compartment 9 comprising, for example, automatic fire extinguishers. Moreover, the released fluids are drained outside through drain holes, for example positioned in the movable cowl 11.

The second compartment 13 comprises equipment which are not sized to withstand contact with the fluids of the first compartment 9, and even less to withstand a fire in said second compartment 13.

Hence, a fluid and fire leak-tight seal 15 is placed between these two compartments 9 and 13, one end of the seal being in particular in contact with the movable cowl 11 when the latter is closed.

However, the movable cowl 11, and more generally the entire nacelle 1, being subjected to vibrations and movements, an anti-friction coating may be placed over the seal 15, thereby allowing making it slide in contact with the movable cowl 11, and therefore not damaging it with the risk of reducing leak-tightness by creating leaks.

FIG. 2 schematically shows a seal 15 fastened to a first element 17 and in contact with a second element 11, for example the movable cowl 11. For example, the seal separates a first compartment 9 and a second compartment 13. An anti-friction coating 19 is affixed onto the seal 15 to facilitate a sliding contact between the seal 15 and the second element 11.

Nevertheless, upon a pipe burst, a fraction of the anti-friction coating 19 might be soaked with fluids 21 of the first compartment 9. By capillarity, the fluids 21 could move along the seal 15 and reach the second compartment 13. This is accentuated by a pressure difference between the first compartment 9 and the second compartment 13. Consequently, the equipment of the second compartment 13 might be deteriorated by this flammable fluid infiltration.

### DISCLOSURE OF THE INVENTION

Hence, the present invention aims to overcome the aforementioned drawbacks and to provide a fire-proof and fluid-tight seal that could also prevent the passage of fluids by capillarity.

An object of the present invention is a seal configured to be arranged between a first element and a second element of a propulsion unit in an assembled configuration, the seal comprising a longitudinal sector intended to be in contact with the second element, the longitudinal sector being formed of a substantially elastic leak-tight material and comprising, a first zone comprising an anti-friction coating, a second zone comprising a leak-tight coating, and a third zone comprising an anti-friction coating.

Thus, the seal is leak-tight, is in a frictionless sliding contact with the second element, and does not enable the passage of a fluid by capillarity at the frictionless contact.

In one embodiment, the transverse width of the second zone is larger than or equal to 0.1 millimetre, preferably between 3 and 10 millimetres.

According to some variants, the anti-friction coating is partially embedded in the leak-tight material or covers the leak-tight material.

Advantageously, the anti-friction material coating comprises a synthetic fibre, preferably poly(m-phenyleneisophthalamide).

In one embodiment, the longitudinal sector comprises at least a fourth zone comprising a leak-tight coating and a fifth zone comprising an anti-friction coating.

Advantageously, the leak-tight material comprises a ceramic fabric and/or elastomeric material.

In one embodiment, the seal comprises an “omega”-type cross-section comprising a substantially planar first portion fastened to the first element and a rounded second portion comprising the longitudinal sector.

In one embodiment, the second zone comprises a break splitting the second zone into two portions on either side of the break, the two portions being transversely offset.

Another object of the present invention is a propulsion unit for an aircraft comprising a first compartment intended to be exposed to a fire and a second compartment, and comprising a seal as defined before between the first compartment and the second compartment, the second zone of the seal being preferably positioned at a distance from the second compartment smaller than its distance with the first compartment.

Another object of the present invention is an aircraft comprising a propulsion unit as defined before and/or a seal as defined before.

### BRIEF DESCRIPTION OF THE DRAWINGS

Other aims, features and advantages of the invention will become apparent upon reading the following description, given merely as a non-limiting example, and made with reference to the appended drawings, wherein:

FIG. 1, which has already been mentioned, is a schematic sectional view of a nacelle of a propulsion unit of an aircraft according to the prior art;

FIG. 2 is a schematic sectional view of a seal according to the prior art;

FIG. 3A and FIG. 3B are respectively schematic sectional and perspective views of an embodiment of a seal according to the invention;

FIG. 4A and FIG. 4B are respectively schematic sectional and perspective views of a first variant of the embodiment of the seal illustrated in FIGS. 3A and 3B;

FIG. 5A and 5B are respectively schematic sectional and perspective views of a second variant of the embodiment of the seal illustrated in FIGS. 3A and 3B;

FIG. 6 is a schematic perspective view of a third variant of the embodiment of the seal illustrated in FIGS. 3A and 3B; and

FIG. 7 is a schematic perspective view of a fourth variant of the embodiment of the seal illustrated in FIGS. 3A and 3B.

### DETAILED DISCLOSURE OF AT LEAST ONE EMBODIMENT

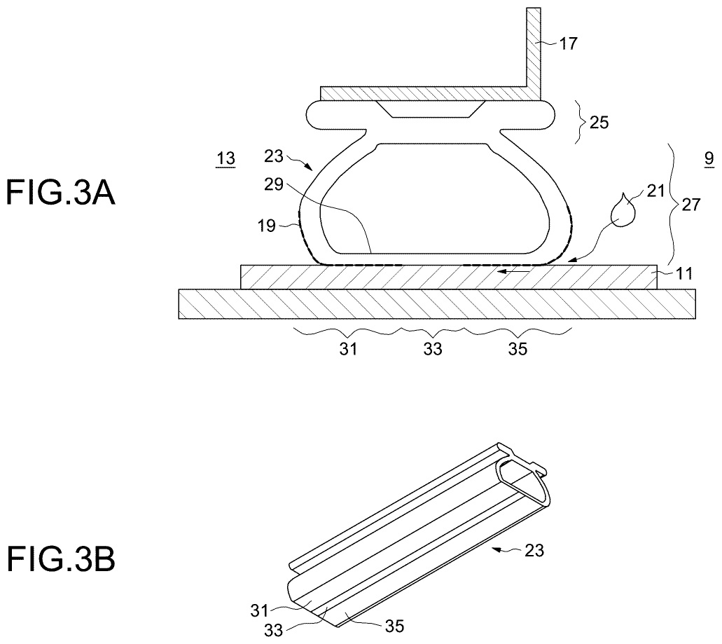

FIGS. 3A and 3B schematically show a first embodiment of a seal 23 according to the invention.

The seal 23 is configured to be arranged between a first element 17 and a second element 11 in an assembled configuration.

For example, the seal 23 has an elongated shape and comprises an “Ω” (omega) type cross-section comprising a substantially planar first portion 25 fastened to the first element 17 and a rounded second portion 27, and more particularly substantially tubular with a longitudinal direction which extends in the axis of this tube, a transverse direction extending perpendicular to the longitudinal direction. However, the seal 23 may have other shapes depending on its use.

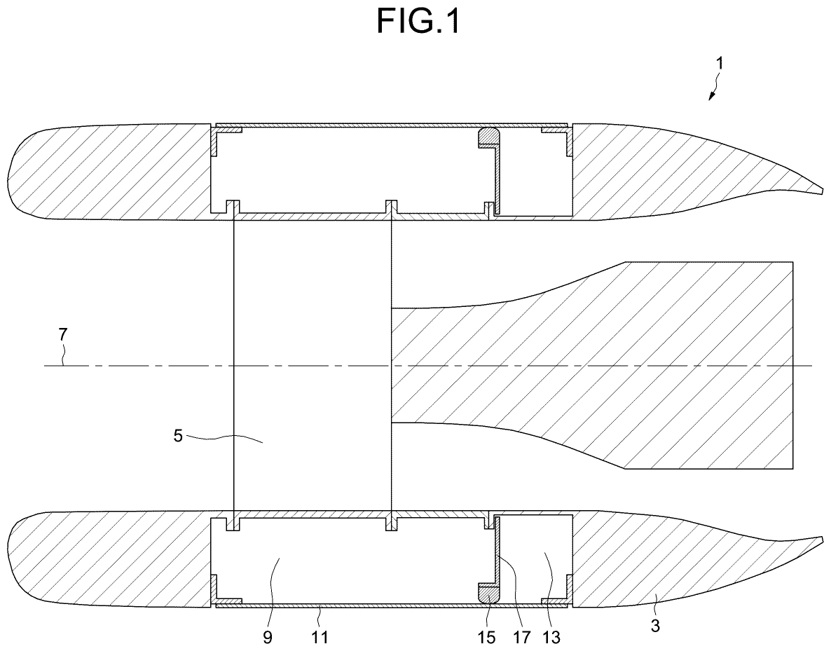

For example, the first element 17 is a wall separating a first compartment 9 and a second compartment 13 and illustrated in FIG. 1.

Thus, for example, the first compartment 9 allows access to an engine and is accessible from the outside by a movable cowl and the second compartment 13 which is juxtaposed with the first compartment comprises a piece of equipment for servo-controlling the thrust reverser of a nacelle of a turbojet engine.

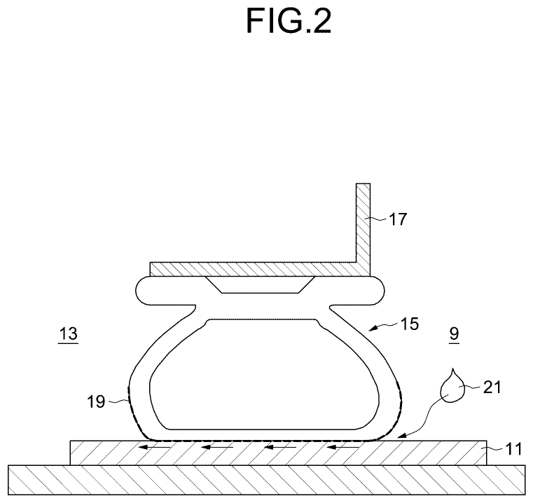

In particular, the seal 23 is fastened to the first element 17 and is intended to be positioned in contact with a second element 11 in the assembled configuration. For example, the second element 11 is the movable cowl 11 mentioned in FIGS. 1 and 2.

The seal 23 separates the first compartment 9 and the second compartment 13 in a leak-tight manner. More particularly, the seal 23 is leak-tight to the fluid and to fire. For example, the seal is included in a propulsion unit of an aircraft.

The second portion 27 of the seal 23 is soft, flexible and comprises a longitudinal sector 29 intended to be in contact with the second element 11. The longitudinal sector 29 is shown flat in the figures so that the seal 23 is shown in an assembled configuration.

The second portion 11 of the seal 23, and consequently also the longitudinal sector 29, is made of a substantially elastic leak-tight material. For example, the leak-tight material comprises a material made of a ceramic and/or elastomeric fabric, for example silicone.

The silicone allows ensuring leak-tightness to the fluid, and has some resistance to high temperatures, whereas its mechanical behaviour is barely dependent on the temperature.

In some embodiments, the leak-tight material comprises glass fabric and/or carbon fabric and/or aramid fabric and/or boron fabric. Such materials, just like ceramic fabrics more generally, allow ensuring a structural reinforcement function of the seal 23 and a fire-proofing function.

The longitudinal sector 29 comprises, arranged side-by-side, a first zone 31 comprising an anti-friction coating 19, a second zone 33 comprising a leak-tight coating, and a third zone 35 comprising an anti-friction coating 19.

As regards the second zone 33, by “leak-tight coating”, it should be understood a wall which is at the surface of the seal 23 and intended to be in contact with the second element 11, this leak-tight coating being formed by exposing the leak-tight material of the longitudinal sector 29, for example by removing an anti-friction coating layer, or being formed by adding a leak-tight coating over an anti-friction coating positioned on the longitudinal sector, the anti-friction coating being used for the first and third zones 31 and 35.

These three zones 31, 33 and 35 extend longitudinally over the longitudinal sector 29 from a first end up to a second end (not shown). In particular, the three zones 31, 33 and 35 transversely form an alternation of zones comprising an anti-friction coating or a leak-tight coating.

The anti-friction coating 19 allows facilitating a sliding contact between the seal 23 and the second element 11. In particular, it allows not deteriorating the seal 23 in the event of slight relative movements between the seal 23 and the second element 11.

For example, the anti-friction coating 19 comprises a synthetic fibre, preferably poly(m-phenyleneisophthalamide), more commonly referred to as Nomex®.

For example, the anti-friction coating 19 is partially embedded in the leak-tight material of the seal 23 and/or covers the leak-tight material so as to create an overlayer.

The second zone 33 does not comprise an anti-friction coating 19 so that a fluid 21 present in one of the two compartments 9 and 13, for example the first compartment 9, and moving by capillarity along the anti-friction coating 19 cannot cross the second zone 33 and thus pass from one compartment to another. To this end, the second zone 33 has a transverse width equal to or larger than 0.1 millimetre.

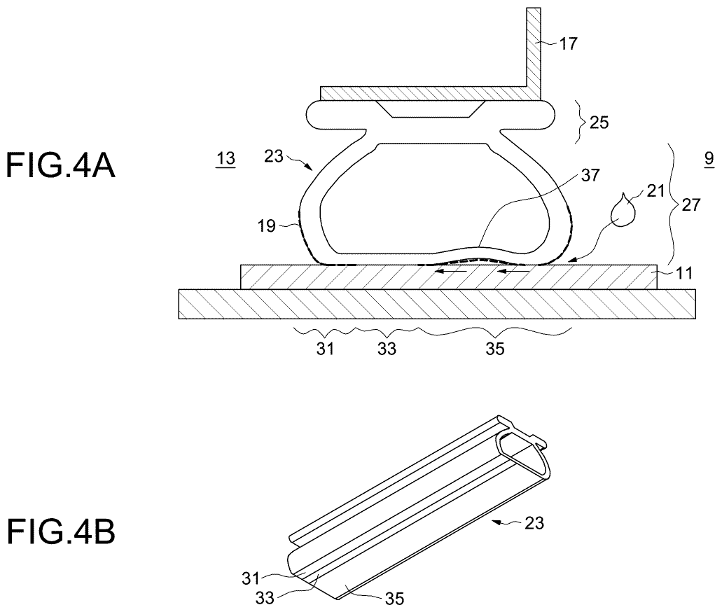

FIGS. 4A and 4B show a first variant of the embodiment illustrated in FIGS. 3A and 3B. In this variant, the first zone 31 is less wide than the third zone 35 so that the second zone 33 is closer to the second compartment 13 than to the first compartment 9. In this variant, the first compartment 9 comprises a fluid 21 that could infiltrate by capillarity or by the presence of deformations 37 in the seal 23. The deformations 37 being predominantly at the centre of the seal 23, the positioning of the second zone 33 according to the variant illustrated in FIGS. 4A and 4B is preferred in order to guarantee that the fluid does not pass from the first compartment 9 to the second compartment 13.

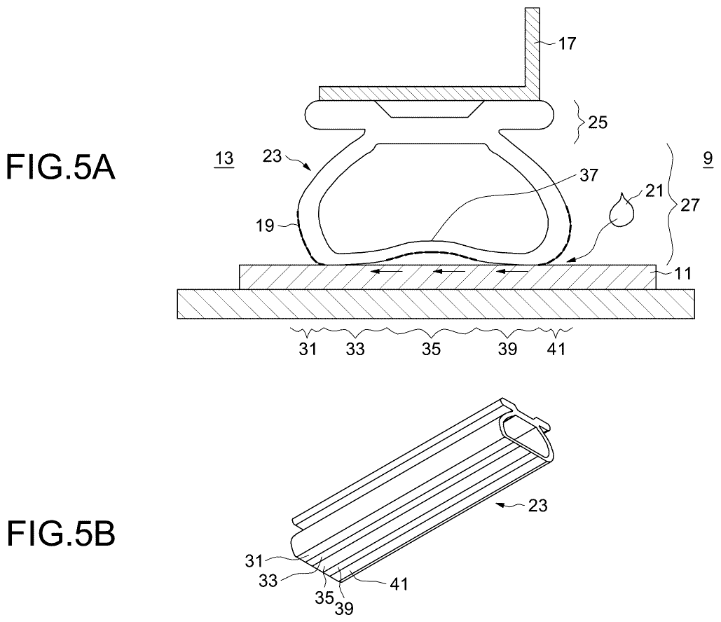

FIGS. 5A and 5B show a second variant of the embodiment illustrated in FIGS. 3A and 3B. In this variant, the longitudinal sector 29 comprises additional zones, namely a fourth zone 39 comprising a leak-tight coating similar to the second zone 33 and a fifth zone 41 comprising an anti-friction coating 19 similar to the first zone 31, the fourth zone 39 and the fifth zone 41 extending longitudinally from a first end to a second end of the longitudinal sector 29. Thus, the first, second, third, fourth and fifth zones 31, 33, 35, 39 and 41 form an alternation of zones comprising an anti-friction coating or a leak-tight coating. More zones may also be added. This variant is useful to ensure almost certainly that the displacement of the fluid 21 by capillarity is actually stopped, despite the presence of deformations 37 in the seal 23, in which deformations 37 fluid 21 could infiltrate.

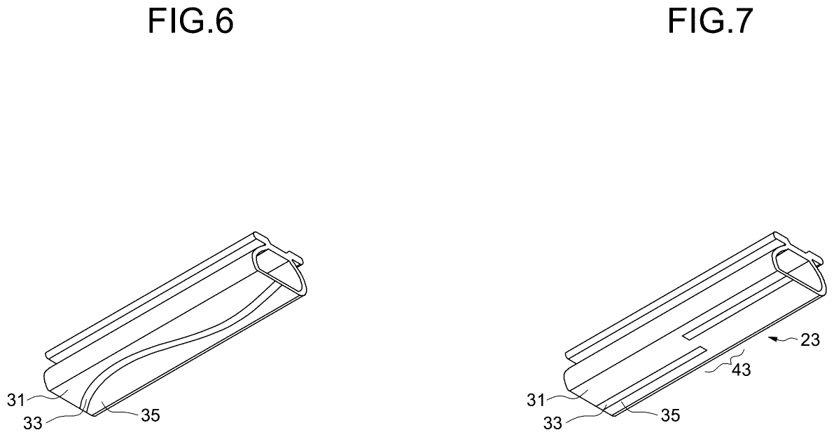

FIG. 6 shows a third variant of the embodiment illustrated in FIGS. 3A and 3B. In this variant, the second zone 33 is not linear and its positioning evolves along the longitudinal sector 29. In particular, some sections of the seal 23 may be subjected to fouling or to physical stresses more rapidly than others. An evolving positioning of the second zone 33 allows avoiding the second zone 33 being positioned on some edges of fouled sections which might lose contact with the second element 11.

FIG. 7 shows a fourth variant of the embodiment illustrated in FIGS. 3A and 3B. In this variant, the second zone 33 comprises at least one break 43 and is split into at least two portions at said break 43. For example, the two portions separated by the break 43 are offset over the width of the seal 23 so that they are not longitudinally aligned. In particular, the two portions are preferably offset transversely and not longitudinally. The first and third zones 31 and 35 are then in contact with each other at the break 43. However, the transverse movement of a fluid by capillarity remains limited by the second zone 33, which always extends over the entire length of the longitudinal sector 29 on either side of the break 43. This variant allows simplifying the manufacture of the seal 23 and also allows positioning the second zone 33 on particular portions of the seal 23, so as to take into account the crushing or the variable fouling of the seal over some sections.

The illustrated different variants may be combined together.

1. A seal configured to be arranged between a first element and a second element of a propulsion unit in an assembled configuration, the seal comprising a longitudinal sector configured to be in contact with the second element, the longitudinal sector being formed of an elastic leak-tight material and comprising, a first zone comprising an anti-friction coating, a second zone comprising a leak-tight coating, and a third zone comprising an anti-friction coating.

2. The seal according to claim 1, wherein a transverse width of the second zone is larger than or equal to 0.1 millimeter.

3. The seal according to claim 1, wherein the anti-friction coating is partially embedded in the leak-tight material or covers the leak-tight material.

4. The seal according to claim 1, wherein the anti-friction material coating comprises a synthetic fiber.

5. The seal according to claim 1, wherein the longitudinal sector comprises at least a fourth zone comprising a leak-tight coating and a fifth zone comprising an anti-friction coating.

6. The seal according to claim 1, wherein the leak-tight material comprises a ceramic fabric and/or elastomeric material.

7. The seal according to claim 1, comprising an “omega”-type cross-section comprising a substantially planar first portion fastened to the first element and a rounded second portion comprising the longitudinal sector.

8. The seal according to claim 1, wherein the second zone comprises a break splitting the second zone into two portions on either side of the break, the two portions being transversely offset.

9. A propulsion unit for an aircraft comprising a first compartment configured to be exposed to a fire and a second compartment, the propulsion unit further comprising the seal according to claim 1 between the first compartment and the second compartment.

10. An aircraft, comprising the propulsion unit according to claim 9.

11. The seal according to claim 2, wherein the transverse width of the second zone is between 3 and 10 millimeters.

12. The seal according to claim 4, wherein the anti-friction material coating comprises a poly(m-phenyleneisophthalamide).

13. The propulsion unit according to claim 9, wherein the second zone of the seal is positioned at a distance from the second compartment smaller than its distance with the first compartment.
